(19) United States
(12) Patent Application Publication
(10) Pub. No.: US 2003/0196347 A1
(43) Pub. Date: Oct. 23, 2003

(54) Printing machine with drying station

(76) Inventors: Wilfried Kolbe, Gulzow (DE); Klaus Schirrich, Bielefeld (DE); Michael Schmitt, Bielefeld (DE); Bodo Steinmeier, Bielefeld (DE)

Correspondence Address: Richard M. Goldberg, Suite 419, 25 East Salem Street, Hackensack, NJ, 07601, US

(21) Appl. No.: 10/390,197

(22) Filed: Mar. 17, 2003

(30) Foreign Application Priority Data
Apr. 23, 2002 (EP) 02 009 128.6

(51) Int. Cl. F26B 3/34

(52) U.S. Cl. 34/273; 34/278; 34/62; 34/114; 34/629

(57) ABSTRACT

A printing machine with several printing units (10), which are arranged in a row and through which a printing carrier sheet (12) passes and downstream from each of which a drying station is disposed, wherein the drying station (22) in each case is disposed at the periphery of an individual tempering roller (26), which supports the printing carrier sheet (12).

The invention relates to a printing machine with several printing units, which are arranged in a row and through which a printing carrier sheet passes and downstream from each of which a drying station is disposed.

Printing machines are divided into central cylinder machines and machines arranged in rows. In the case of a central cylinder machine, the printing units, with which the individual color separations are printed with register accuracy on the printing carrier, are disposed at the periphery of a common central cylinder. In order to speed up the drying of the freshly printed ink, it is known that infrared radiators, hot air dryers or UV radiators may be disposed at the periphery of the central cylinder, so that the printing carrier sheet, supported on the central cylinder, is irradiated when it has left the printing unit in question. On the other hand, in the case of a machine constructed in a row, the individual printing units, which in each case have a printing cylinder and a counter-pressure cylinder, are disposed one after the other in a row and the printing carrier sheet is guided, so that it runs consecutively through the roller gaps formed between the printing cylinders and the counter-pressure cylinders of the individual printing units. Each drying station has a largely closed housing, in which hot drying air is blown onto the freshly printed sheet, while it runs consecutively over several guiding rollers, which support the back of the printing carrier sheet.

So that the printing ink dries sufficiently before entry in the next printing unit, the drying station must have a sufficient length and/or a sufficiently high drying temperature must be selected. There are however limits to increasing the drying temperature, because most printing carrier sheets, when dried, tend to shrink more or less, depending on the material, in the longitudinal direction as well as in the transverse direction, so that there are register errors, when the individual color separations are printed one about the other. A further disadvantage of the conventional drying stations in the case of a machine of row construction consists therein that the individual guiding rollers in each case support the printing carrier sheet only linearly, whereas the spaces between the individual guiding rollers are covered freely by the printing carrier sheet. The drying air, blowing on the sheet, can therefore lead to appreciable mechanical stresses as well as to a fluttering and possibly a displacement of the printing carrier sheet.

It is an object of the invention to provide a printing machine of the type named above, which makes an efficient and, nevertheless, gentle drying of the printing carrier sheet possible.

Pursuant to the invention, this objective is accomplished owing to the fact that the drying stations in each case are disposed at the periphery of an individual tempering roller, which supports the printing carrier sheet.

Accordingly, since the printing carrier sheet in the drying station is supported two-dimensionally over a larger peripheral angle of the tempering roller, fluttering of the printing carrier sheet as well as a displacement of the latter, when drying air or a different drying medium is blown on it, can be largely avoided and the mechanical stress on the printing carrier sheet is also decreased appreciably. A further significant advantage of the invention consists therein that, because the printing carrier sheet rests two-dimensionally on the tempering roller, an appreciable portion of the drying heat can be carried away over the reverse side of the printing carrier sheet. A temperature gradient thus is formed in the printing carrier sheet in the sense that the temperature of the printing carrier sheet decreases from the printed side, onto which drying air is blown and/or which is irradiated with infrared or UV radiation. Accordingly, a high drying temperature and, with fact, an efficient drying of the printing ink can be achieved on the printed side, whereas the average temperature over the thickness of the printing carrier sheet remains relatively low, with the result that the thermal shrinkage of the printing carrier sheet remains relatively low in spite of the high, effective drying temperature. The danger of register errors is thus decreased appreciably, on the one hand, due to the lesser shrinkage of the printing carrier sheet and, on the other, due to the better guidance and support of the printing carrier sheet. This solution is particularly advantageous in the case of printing carrier sheets, which have a great tendency to shrink because of the material, such as plastic sheets.

A further advantage of the invention consists therein that the drying stations can be simplified structurally since, instead of several guiding rollers, they require in each case only a single tempering roller, so that the required bearings and driving devices are reduced.

Advantageous developments of the invention arise out of the dependent claims.

To achieve a high drying temperature, the drying station may have blowing nozzles for a hot drying medium, as well as infrared or UV radiators or a combination of blowing nozzles and radiators.

The tempering roller preferably has a casing with a high thermal conductivity, over which the drying heat can be carried away effectively. In a particular preferred embodiment, the tempering roller has a cooling jacket, the temperature of which can be controlled by a thermostat. The cooling jacket may have a system of cooling chambers, through which a liquid cooling medium, such as water, is flowing.

In the following, an example of the invention is described in greater detail by means of the drawing, in which

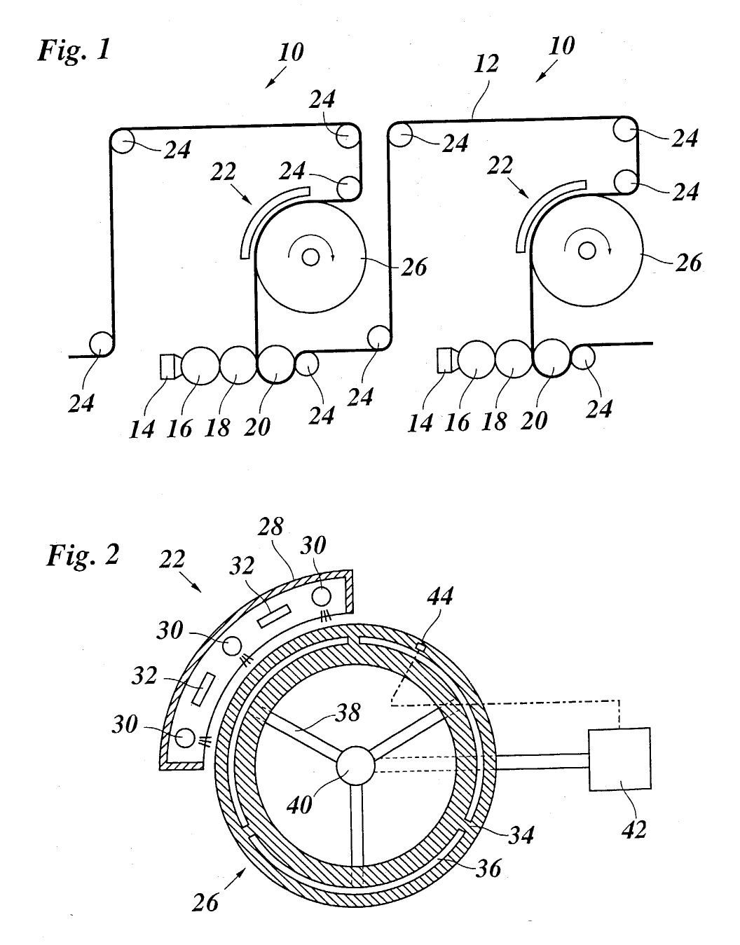

FIG. 1 shows a diagrammatic view of two inking units of a printing machine and

FIG. 2 shows an enlarged diagrammatic section through one drying station.

FIG. 1 shows a part of a flexographic printing machine, which is constructed in a row with several printing units 10, through which the printing carrier sheet 12 passes consecutively. Each printing unit 10 comprises a chambered doctor blade 14, an anilox roller 16, a printing cylinder 18, a counter-pressure cylinder 20 and a drying station 22, as well as several guide rollers 24 for the printing carrier sheet.

At its surface, the anilox roller 18 has a grid of fine cells and, as it passes through the chambered doctor blade 14, it is inked with printing ink. The printing cylinder 18 rolls along the anilox roller 16, so that the printing parts of the block take over the printing ink from the anilox roller 16. The printing carrier sheet 12 is printed when it passes through a gap between the printing cylinder 18 and the counter-pressure cylinder 20 and then enters the associated drying station 22, in which the freshly applied printing ink is dried, before the printing carrier sheet is passed on the over the guide rollers 24 to the next printing unit.

The drying station 22 is disposed at the periphery of a tempering roller 26 and extends over a larger circumferential angle of the tempering roller 26; in the example shown, it extends over a circumferential angle of about 45°, over which the printing carrier sheet 12 lies two-dimensionally against the peripheral surface of the tempering roller 26.

As shown in FIG. 2, the drying station 22 has a housing 28, which follows the surface curvature of the tempering roller 26 and is open towards the tempering roller. This housing 28 accommodates several blowing nozzles 30, from which a hot drying medium, such as a hot air, is blown onto the surface of the printing carrier sheet in contact with the tempering roller 26. In the example shown, the housing 28 contains, in addition, also several radiators 32, such as infrared radiators, with which the surface temperature of the printing carrier sheet and, with that, the drying effect can be increased.

The tempering roller 26 has a cooling jacket 34, which forms several cooling chambers 36, which are distributed uniformly over the periphery of the tempering roller and through which a cooling medium, such as water, is flowing. The cooling chambers 36 are connected over a pipeline system 38 and, over rotating unions 40, is connected, with a recirculating system 42 for the cooling medium, the rotating unions 40 being disposed at one or both ends of the tempering roller. The outer circumferential wall of the cooling jacket 34, which is in contact with the printing carrier sheet in the region of the drying station 22, consists of a material with a high thermal conductivity. In this peripheral wall, preferably at several places distributed over the periphery and in the axial direction, temperature sensors 44 are embedded, which report the measured temperature of the cooling jacket 34 to the recirculating system 42, so that the temperature of the cooling jacket can be controlled thermostatically. Instead of the temperature sensors 44, a sensor may also, alternatively, be provided, which measures the return temperature of the cooling medium.

Accordingly, on passing through the drying station 22, the printing carrier is heated on the printed, outer side with the help of the blowing nozzles 30 and the radiators 32, while the rear of the printed carrier sheet is cooled by the cooling jacket 34. In this way, a high surface temperature and a correspondingly effective drying can be achieved on the printed side of the printing carrier sheet, while the temperature of the printing carrier sheet, as a whole, remains relatively low, so that thermal shrinkage of the printing carrier sheet is reduced to a minimum. The efficient drying of the printing carrier sheet is supported further owing to the fact that the solvent vapors, which are evaporating from the printing ink, are discharged rapidly with the help of the drying air emerging from the blowing nozzles 30. Since the printing carrier sheet lies two-dimensionally against the peripheral surface of the tempering roller 26, the drying air may emerge with a relatively high flow velocity from the blowing nozzles 30, so that the drying effect can be increased further without excessive mechanical stress or fluttering of the printing carrier sheet.

The cooling medium, recirculated in the cooling jacket 34, can be used not only for cooling, but also, for example, for pre-heating the tempering roller 26 to a suitable operating temperature before the start of the printing operation, so that optimum temperature conditions exist in the drying station 22 from the very start. The heat, carried away with the cooling medium, can be utilized with the help of a heat exchanger system for pre-heating the drying air, so that energy-saving drying of the printing carrier sheet becomes possible.

The invention was described here using a flexographic printing machine as an example. It can, however, also be employed for other printing machines, such as gravure printing machines.

1. A printing machine with several printing units (10), which are arranged in a row and through which a printing carrier sheet (12) passes and downstream from each of which a drying station (22) is disposed, wherein the drying station (22) in each case is disposed at the periphery of an individual tempering roller (26), which supports the printing carrier sheet (12).

2. The printing machine of claim 1, wherein each printing station (20) has at least one blowing nozzle (30) for blowing a hot drying medium onto the printing carrier.

3. The printing machine of claims 1 or 2, wherein each drying station has at least one radiator (32) for irradiating the printing carrier (12) with thermal radiation and/or ultraviolet radiation.

4. The printing machine of one of the preceding claims, wherein the tempering roller (26) has a thermostatically controlled cooling jacket (34).

5. The printing machine of one of the preceding claims, wherein the tempering roller (26) has at least one cooling chamber (36) and one recirculating system (42) for recirculating a cooling medium in the cooling chamber (36).
